(19) United States
(12) Patent Application Publication
(10) Pub. No.: US 2023/0031690 A1
(43) Pub. Date: Feb. 2, 2023

(54) PROTEIN SKIMMER NECK INSERT

(71) Applicant: Kyle James Robert Elder, Haymarket, VA (US)

(72) Inventor: Kyle James Robert Elder, Haymarket, VA (US)

(21) Appl. No.: 17/817,837

(22) Filed: Aug. 5, 2022

Related U.S. Application Data
(60) Provisional application No. 63/202,327, filed on Jun. 7, 2021.

(51) Int. Cl. B01D 21/24; C02F 1/40

(52) U.S. Cl. CPC B01D 21/2433; C02F 1/40; C02F 2103/20

(57) ABSTRACT

An insert designed for use with a protein skimmer is disclosed. The insert includes one or more tubes that define an opening with a diameter. This diameter is designed to be smaller than the protein skimmer neck's diameter. The one or more tubes are insertable and retained by the protein skimmer neck to adjust the effective diameter of the protein skimmer neck's opening.

### CROSS-REFERENCE TO RELATED APPLICATION

This application claims the benefit of priority of U.S. provisional application No. 63/202,327, filed Jun. 7, 2021, the contents of which are herein incorporated by reference.

### BACKGROUND OF THE INVENTION

The present invention relates to protein skimmers and, more particularly, to a neck insert to change the characteristics of a protein skimmer and how it can be changed or tuned.

Tuning a protein skimmer to individual reef systems can be difficult. It can also be almost impossible to size the protein skimmer to a user's system water volume.

There are no options other than buying different skimmers as no protein skimmer on the market had an adjustable neck size. Sizing a protein skimmer to different water volumes and chemistry is almost impossible at this time. There are only a few adjustments that are available for protein skimmers.

As can be seen, there is a need for a device that allows a user to change the characteristics of a protein skimmer.

### SUMMARY OF THE INVENTION

In one aspect of the present invention, an insert is disclosed that is configured for use with a protein skimmer that comprises a protein skimmer neck with a neck diameter, the insert comprising: a first tube defining a first tube opening with a first tube diameter, the first tube diameter being configured to be smaller than the neck diameter, wherein the first tube is configured to be inserted into and retained by the protein skimmer neck.

In another aspect of the present invention, a system is disclosed that comprises: a protein skimmer comprising a protein skimmer neck with a neck diameter; an insert comprising: a first tube defining a first tube opening with a first tube diameter, the first tube diameter being smaller than the neck diameter, wherein the first tube is insertable into and retainable by the protein skimmer neck.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a side elevation view of an embodiment of the present invention, shown in use;

FIG. 2 is a detail elevation view of a protein skimmer of the embodiment of the present invention;

FIG. 3 is an exploded elevation view of the embodiment of the present invention; and

FIG. 4 is a cross-sectional view of the embodiment of the present invention, taken on line 4-4 of FIG. 2.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

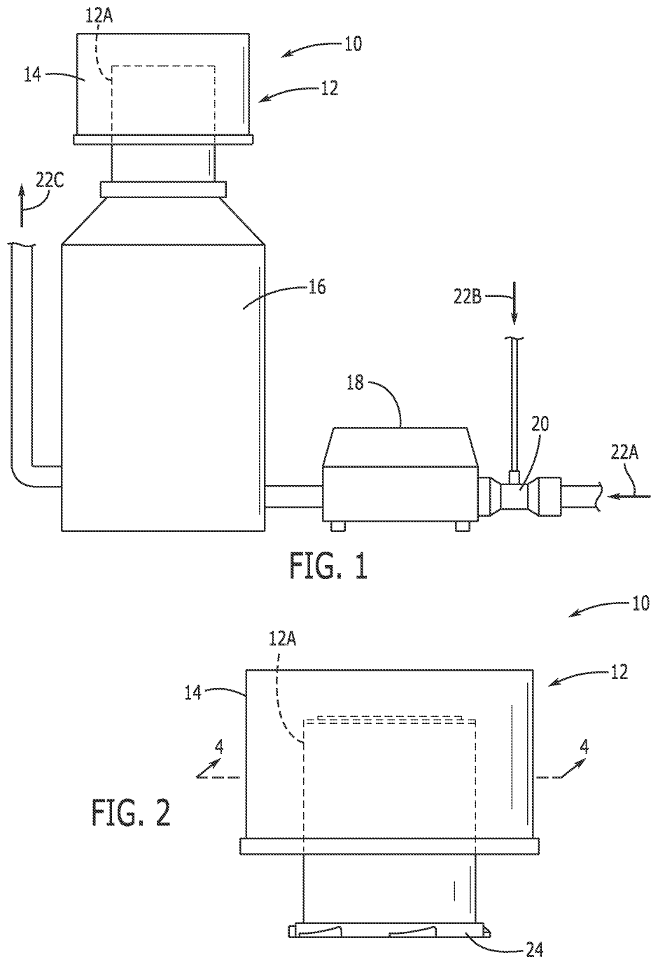

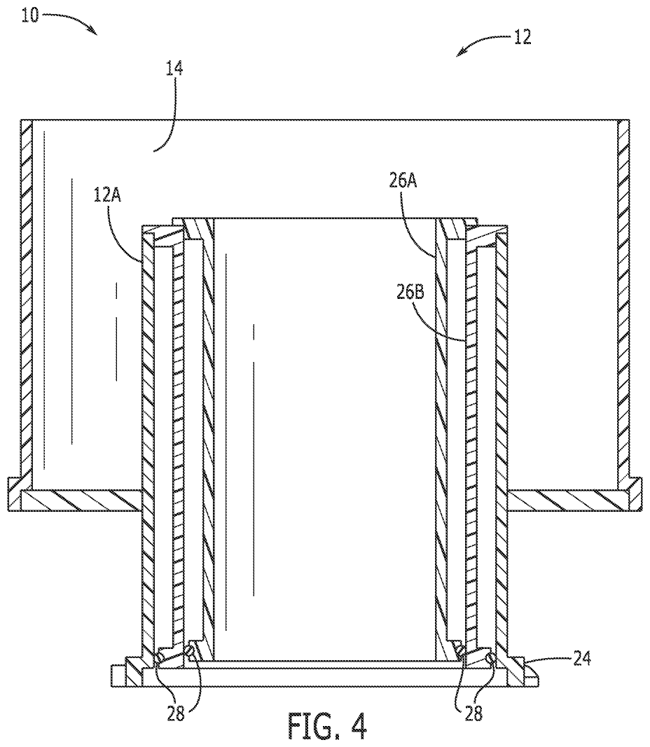

Referring, for example, to FIGS. 1 and 4, an embodiment of the present invention provides a protein skimmer insert 10 that is mounted in a protein skimmer neck 12A of a protein skimmer 12 (the protein skimmer 12 including a collection cup 14) to adjust a diameter of the opening. In certain embodiments of the present invention, a neck insert 10 is disclosed that fundamentally changes the performance and size of a protein skimmer 12.

The present invention gives the end-user the ability to match the skimmer size to their system's volume in real-time. There is no comparison to this other than buying multiple skimmers 12 of different sizes. This changes an existing skimmer's neck size from large to small, or small to large. This device 10 allows for better adjustment as a user's system initially is set up and grows. A system's water chemistry and volume can change over time, and this product 10 can change with it by providing a variable size neck opening.

As those with skill in the art will appreciate and as shown in FIG. 1, as part of an overall system, a protein skimmer 12 couples to a reaction chamber 16 via an attachment flange 24. The reaction chamber 16 is fluidically coupled to an outlet side of a water pump 18. An inlet side of the water pump 18 has a venturi valve 20 coupled thereto. In use, the system also includes a water intake 22A, an air intake 22B, and a water output 22C.

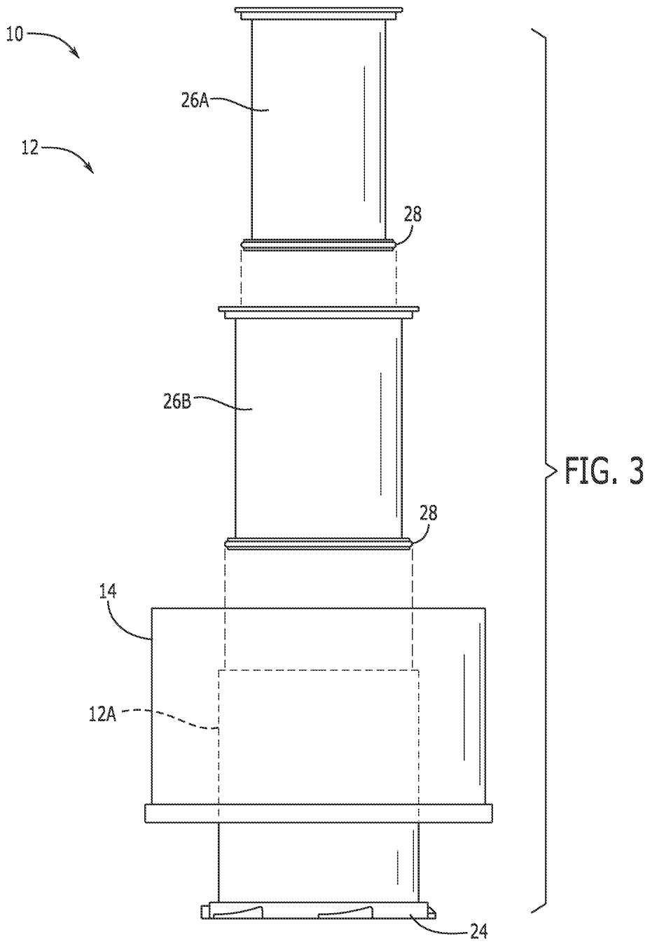

Referring to FIGS. 3 and 4, one or more tubes 26A, 26B are provided that change the size of a skimmer neck 12A, these tubes 26A, 26B functioning as a protein skimmer insert. The tubes 26A, 26B may be formed from, for example, acrylic or plastic. Each tube 26A, 26B, includes a top ring (upper rims/ledges of the tubes 26A, 26B, functioning as a retention ring) at an upper distal end and a bottom ring (lower rims/ledges of the tubes 26A, 26B, functioning as a centering ring) at a lower distal end. These rings are also formed from acrylic or plastic. The rings hold the tubes 26A, 26B in place, with the tubes 26A, 26B changing the size of the skimmer neck 12A. The top ring is needed to keep the respective tube 26A, 26B centered in the neck 12A of the skimmer 12. The bottom ring can be selectively removed/omitted, in certain embodiments, but the top ring is needed to keep the tube 26A, 26B in place. A pressure fit O-ring 28 (which engages an inner wall of the component the tube 26A, 26B is inserted int) is provided that seals the skimmer neck 12A and prevents the skimate or bubbles from escaping.

As shown in FIG. 4, the tubes 26A, 26B are shaped and sized such that a smaller tube 26A (with a smaller inner diameter) is nestable within a larger tube 26B, with the top ring of the smaller tube 26A having an upper ledge that rests on an upper surface of the top ring of the larger tube 26B. In a similar vein, the top ring of the larger tube 26B has an upper ledge that rests on an upper surface of the skimmer neck 12A. Thus, the design of the top rings maintain the tubes 26A, 26B in position and enable an effective diameter of the skimmer neck 12A to be reduced or increased as needed (e.g., only the larger tube 26B may be used, if a larger diameter is needed/wanted). As shown in FIG. 4, the larger tube 26B has a smaller diameter than a diameter of the skimmer neck 12A, and the smaller tube 26A has a smaller diameter than the diameter of the larger tube 26B.

Advantageously, and in accordance with certain aspects of the present invention, changing the neck size to match individual parameters (e.g., dissolved protein, water chemistry, and bio-load) with a single device 10 allows users to fine-tune foam production and have their protein skimmer 12 work more efficiently for their system at their current bio-loads. Bio-load in an aquarium can change often, and the teachings of the present invention permit a user to expand or shrink the capabilities of a protein skimmer 12 by changing how much foam is needed. Shrinking or enlarging the skimmer neck 12A changes how the skimmer 12 performs, e.g., smaller necks 12A require less dissolved bio than larger necks. This also changes the amount of foam head needed to reach the collection cup 14.

A method of making the present invention may include the following. Acrylic or plastic tubing is cut to size. Insert rings are milled or machined to appropriate size. These parts are then adhered together, and a ring around the top or bottom may be added, as needed. As mentioned, the ring for retention is needed to keep the tube centered in the neck of the skimmer. Removing the ring from the bottom, in certain embodiments, can be done but the top ring is needed to keep the tube in place.

A method of using the present invention may include the following. The protein skimmer insert(s) 26A, 26B is/are placed into the neck 12A of the protein skimmer. They are removed or added to change the neck's overall diameter and size.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The term “substantially” shall be interpreted to mean completely and/or nearly completely. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An insert configured for use with a protein skimmer that comprises a protein skimmer neck with a neck diameter, the insert comprising:
a first tube defining a first tube opening with a first tube diameter, the first tube diameter being configured to be smaller than the neck diameter, wherein the first tube is configured to be inserted into and retained by the protein skimmer neck.

2. The insert of claim 1, further comprising a top ring configured to engage an upper surface of the protein skimmer neck.

3. The insert of claim 2, further comprising an O-ring provided at a lower distal end of the first tube, the O-ring being configured to engage an inner wall of the protein skimmer neck.

4. The insert of claim 3, further comprising a second tube configured to be inserted into and retained by the first tube.

5. A system comprising:
a protein skimmer comprising a protein skimmer neck with a neck diameter; and
an insert comprising:
a first tube defining a first tube opening with a first tube diameter, the first tube diameter being smaller than the neck diameter, wherein the first tube is insertable into and retainable by the protein skimmer neck.

6. The system of claim 5, wherein the insert further comprising a top ring that engages an upper surface of the protein skimmer neck.

7. The system of claim 6, wherein the insert further comprises an O-ring provided at a lower distal end of the first tube, the O-ring being engageable with an inner wall of the protein skimmer neck.

8. The system of claim 7, wherein the insert further comprises a second tube that is insertable into and retainable by the first tube.
